(19) United States
(12) Patent Application Publication
(10) Pub. No.: US 2012/0124518 A1
(43) Pub. Date: May 17, 2012

(54) Managing Operations via a User Interface

(75) Inventors: Christine C. Stawitz, Seattle, WA (US); Gerald Paul Joyce, Bremerton, WA (US); William R. Orr, Bellevue, WA (US); Petru Iulian Cociorva, Redmond, WA (US); Peter Seraphim Ponomarev, Seattle, WA (US); Manav Mishra, Kirkland, WA (US); Jeffrey Jay Johnson, Bellevue, WA (US); Steven J. Ball, Seattle, WA (US)

(73) Assignee: MICROSOFT CORPORATION, Redmond, WA (US)

(21) Appl. No.: 12/947,391

(22) Filed: Nov. 16, 2010

(51) Int. Cl. G06F 3/048

(52) U.S. Cl. 715/810

(57) ABSTRACT

Techniques for managing operations via a user interface are described. In implementations, a user interface is displayed that includes an option to cause serial processing of multiple operations. In response to a user selection of the option, the multiple operations are processed serially.

### BACKGROUND

As computers become increasingly user friendly, more and more operations are automated and performed in the background to enable users with little to no computing skills to operate the computers. This may be beneficial for average users with little knowledge regarding background processing of the operations. Often times, however, advanced users may find this automation undesirable for a variety of reasons. For example, advanced users may have a desire but lack the capability using traditional techniques to manually manipulate the computing system in order to improve performance. This lack of control may lead to user frustration for these users.

### SUMMARY

Techniques for managing operations via a user interface are described. In implementations, a user interface is displayed that includes an option to cause serial processing of multiple operations. In response to a user selection of the option, the multiple operations are processed serially.

In implementations, a user interface is configured to display an identifier of each of a plurality of operations. The user interface is further configured to communicate with a processor to serially process the operations in response to a user input. The user input includes a change to a priority level of one or more of the operations. In addition, a sequence in which the operations are to execute is reordered in response to the change to the priority level.

In implementations, one or more computer-readable media comprise instructions that are executable by a computing device to determine whether to permit parallel processing of at least some a plurality of operations by at least detecting if a processing volume supports concurrent access to a resource by the at least some of the plurality of operations. A user interface is displayed that is configured to enable user selection of parallel processing or serial processing of at least some of the plurality of operations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques for managing operations via a user interface described herein.

FIG. 2 is an illustration of a system in an example implementation that is operable to employ techniques for managing operations via a user interface described herein.

FIG. 3 is an illustration of an example user interface in accordance with an embodiment of techniques for managing operations via a user interface described herein.

FIG. 4 is a flow diagram depicting a procedure in an example implementation that is operable to provide techniques for managing operations via a user interface.

FIG. 5 is a flow diagram depicting a procedure in an example implementation that is operable to provide techniques for managing operations via a user interface.

FIG. 6 illustrates various components of an example device that can be implemented as any type of portable and/or computer device as described with reference to FIGS. 1-5 to implement embodiments of the techniques for managing operations via a user interface described herein.

### DETAILED DESCRIPTION

Overview

Traditional techniques that were used to process operations and/or copy content may become inefficient when confronted with a large amount of content. For example, the processing of multiple operations in parallel may slow performance for the operations, both individually and as a group.

Techniques for managing operations via a user interface are described. In implementations, a user interface provides a user with an option to execute multiple operations serially, or asynchronously. For example, the user interface can communicate with an operations module to pause execution of some of the operations to allow a single operation to execute at a time. A queue may also be provided to allow the user to view a sequence in which the operations are to execute. The queue may be used for a variety of purposes, such as to reorder a sequence by changing a priority level of one or more of the operations. In this way, the user is provided with a measure of control over the performance of the operations.

In the following discussion, an example environment is first described that is operable to employ techniques for managing operations via a user interface described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

Example Environment

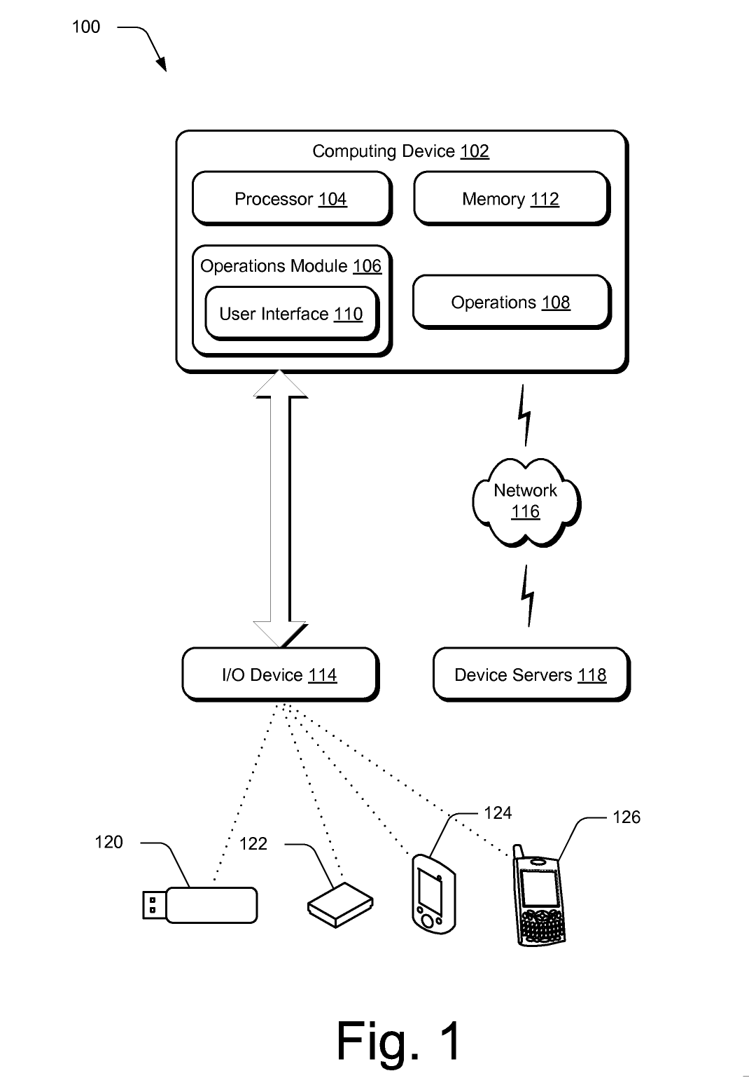

FIG. 1 is an illustration of an environment 100 in an example implementation that is operable to employ techniques for managing operations via a user interface. The illustrated environment 100 includes a computing device 102, a processor 104, and an operations module 106, each of which are communicatively coupled, one to another. The operations module 106 may be configured to manage multiple operations 108 which are to execute. Additionally, the operations module 106 may include a user interface 110 for displaying information to a user. The computing device 102 may also include a memory 112 for storing data and may be communicatively coupled to one or more I/O devices 114. The illustrated environment 100 also includes a network 116, such as the Internet, and one or more device servers 118 from and to which content can be received and sent, as described below.

The computing device 102 may be configured in a variety of ways. For example, the computing device may be configured as a desktop computer, a mobile station, an entertainment appliance, a set-top box communicatively coupled to a display device, a wireless phone, a game console, and so forth. Thus, the computing device may range from a full resource device with substantial memory and processor resources (e.g., personal computers, game consoles) to low-resource devices with limited memory and/or processing resources (e.g., traditional set-top boxes, hand-held game consoles). The computing device 102 may also relate to an entity that operates the computing device 102, e.g., software.

The operations module 106 is representative of functionality associated with managing and controlling operations 108. For example, the operations module 106 may be configured to pause and/or resume performance of one or more of the operations 108 to manage performance of the operations 108 in an established sequence.

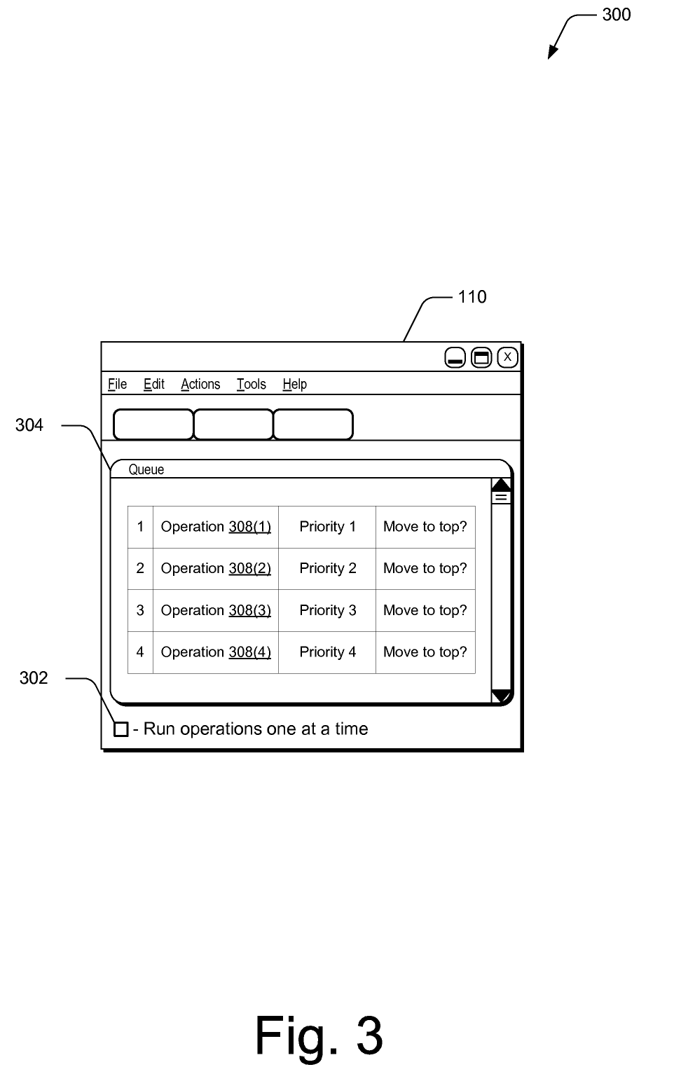

This functionality may be implemented in a variety of ways. For example, the operations module 106 may be configured to generate a user interface 110 to enable a user to manually manage the operations 108. A user can provide one or more inputs via the user interface 110 to manage multiple operations 108. Further discussion of an example of such management is discussed in relation to FIG. 3.

Operations 108 that are manageable by the operations module 106 in FIG. 1 may be representative of a variety of different operations. For example, the operations 108 may involve functionality associated with the memory 112, the I/O device 114, the processor 104, and so on. Thus, the operations 108 may include an input and/or output to or from another device, read and/or write operations, file copy or transfer operations, and so on. Accordingly, the operations 108 may include a multitude of operations that are to execute. The following describes example componentry used in performing the operations 108.

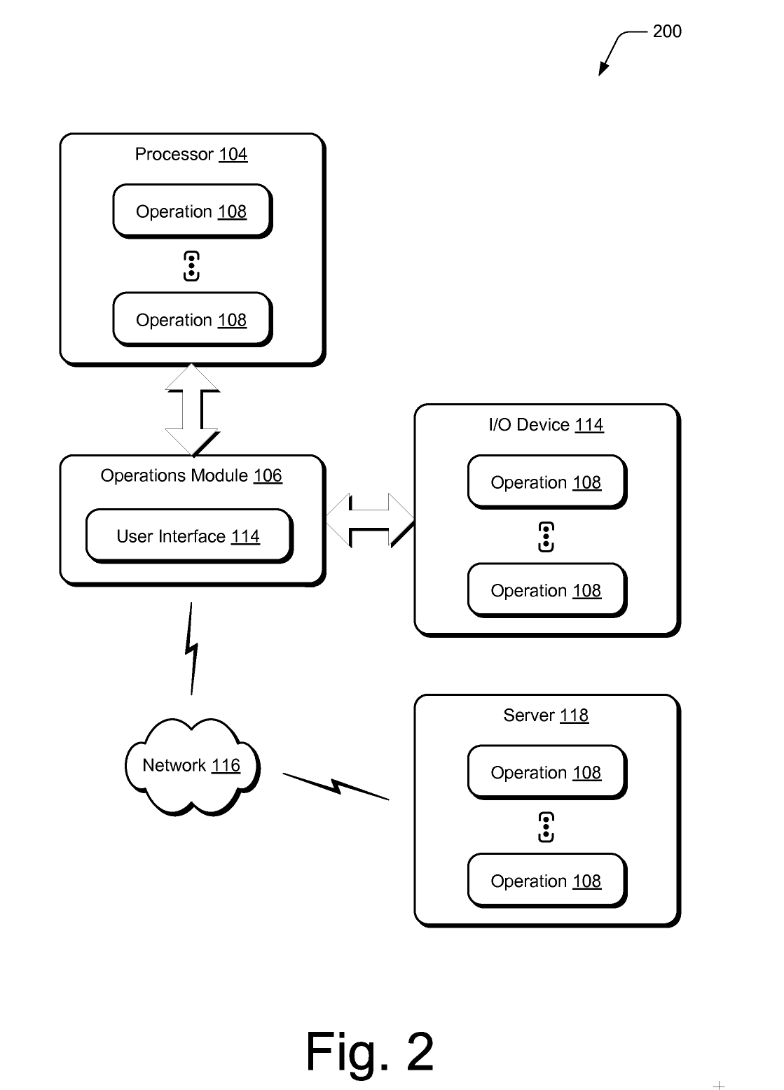

For example, the operations 108 may be executed by the processor 104 or other component on the computing device 102. Alternatively, a processor or other component on the I/O device 114 or on the device server 118 may perform the operations 108. Further, any combination of one or more computing devices 102, one or more I/O devices 114, and/or one or more device servers 118 and components thereof may be used to perform the operations 108. A detailed description of example configurations of processors and devices is provided below with respect to FIG. 2.

Memory 112 represents one or more computer storage media. Memory 112 can include volatile media (such as random access memory (RAM)) and/or nonvolatile media (such as read only memory (ROM), Flash memory, optical disks, magnetic disks, and so forth). Memory 112 can include fixed media (e.g., RAM, ROM, a fixed hard drive, etc.) as well as removable media (e.g., a Flash memory drive, a removable hard drive, an optical disk, and so forth).

The I/O device 114 may assume a wide variety of configurations. For example, the I/O device 114 may include a thumb drive 120, an external memory or modem 122, a media player 124, a smart phone 126, a printer, a laptop or any other computing device, a set-top box, and so on. The I/O device 114 may be communicatively coupled to the computing device 102 via a bus that allows the I/O device 114 to communicate with the computing device 102 and/or the various components of the computing device 102. The bus represents one or more of any of several types of bus structures, including a memory bus or memory controller, a peripheral bus, an accelerated graphics port, and a processor or local bus using any of a variety of bus architectures, including wired and/or wireless buses.

The network 116 may assume wide variety of configurations. For example, the network 116 may include a wide area network (WAN), a local area network (LAN), a wireless network, a public telephone network, an intranet, and so on. Further, although a single network is shown, the network 116 may be configured to include multiple networks.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques for managing operations via a user interface described below are platform-independent, meaning that the techniques may be implemented on a variety of commercial computing platforms having a variety of processors.

Although the operations 108 are illustrated as residing on the computing device, other configurations are also contemplated. For instance, consider FIG. 2, which illustrates an environment 200 in an example implementation that is operable to employ techniques for managing operations via a user interface described herein. The illustrated environment 200 includes an operations module 106, a processor 104, an I/O device 114, and a server 118. The operations module may be communicatively coupled to the processor 104 or the I/O device 114 directly via a bus or any other suitable connection. In addition, the operations module 106 may be communicatively coupled to the server 118 via a network 116, such as the Internet.

The operations module 106 may be configured to control or manage performance of multiple operations 108. These operations 108 may be output by the processor 104, the I/O device 114, the server 118, or on any combination or module thereof This is illustrated in FIG. 2 by the use of the same reference number for each operation. Operations 108 may include a variety of operations, such as operations to copy a file or a group of files, read or write to a memory, and so on.

The operations module 106 allows control and management of the multiple operations 108 by a user via the user interface 110. The user interface 110 may provide one or more options for user selection to, for example, perform the multiple operations 108 serially or in parallel. Other user selectable options may include changing a priority level or a sequence of the operations to reorder the operations in a queue.

When a user selects the option to run the operations 108 one at a time, the user interface 110 may communicate with the operations module 106 to place one or more, or all but one, operations in a pending state to allow performance of a single operation 108. For example, callback methods may be used to communicate with the operations module 106 to start or stop performance of one or more operations 108. This enables more resources to be directed at the single operation 108, thus avoiding prolonged performance that may occur as a result of sharing resources among multiple operations performing in parallel.

The performance of the operations 108 may be bound by the I/O device on which the operations 108 reside, rather than the computing device upon which the operations module 106 resides. For example, multiple read or write operations performed on the same hard drive may be limited by the capabilities of modules of the hard drive. Thus, processing speed of the multiple read or write operations in parallel may be reduced due to the limitations of the hard drive. The processing speed may also be reduced due to various characteristics of the I/O device. However, the techniques for managing operations via a user interface described herein provide the user with substantial control over improving the performance of the operations 108. An example of the above described user interface 110 is illustrated in FIG. 3.

Implementation Example

FIG. 3 illustrates an example implementation 300 of a user interface 110 operable to provide techniques for managing operations via the user interface 110. In implementations, the user interface 110 provides a user with an option 302 to perform multiple operations serially, e.g., asynchronously, sequentially, and so on. For example, the user interface 110 may negotiate with individual operations to control those individual operations and place them in a pending state. The option 302 may be configured as a selectable button, a checkbox, a pull-down menu, or any other component for receiving user input. The user interface 110 may also provide a queue 304 that includes a list of operations 108(1)-(4) which are to execute. The operations 108(1)-(4) may include any number of operations. For purposes of illustration only, however, four operations 108(1)-(4) are shown in FIG. 3. More operations may be included in the queue 304 and may be viewable by manipulating a vertical scroll bar as shown in the illustrated example.

The user interface 110 may be displayed after multiple operations are specified to run to enable a user to change settings related to performance of the multiple operations. Alternatively, the user interface 110 may pop up when multiple operations are running Additionally, changes made to the settings by the user may persist or may reset to default settings. For example, if a user specifies a relatively high priority level for a certain operation in comparision to other operations in the queue, then when a similar operation is performed, the similar operation may be automatically assigned the same high priority and placed at or near the top of the queue 304. Other embodiments are also contemplated.

For example, the user may specify a priority level for a type of operation, or for any operation associated with a certain file or application. Accordingly, an additional operation that is of the same type or is associated with the same file or application as the first operation may be automatically assigned the same priority level and placed in the queue 304 in a position that corresponds to that particular priority level. For instance, an operation with a low priority level may be placed at or near the bottom of the queue 304. Alternatively, an option may be provided to the user to reset the settings upon completion of the operation and use default settings for similar operations, operations of the same type, or operations associated with the same file or application.

The queue 304 may include a variety of configurations. For example, as shown in FIG. 3, the queue 304 may comprise multiple rows and columns. The operations 108 that are scheduled for performance may be listed in the queue 304 in a sequence that demonstrates the order in which the operations 108 are to be performed serially. Additional operations may be added to the queue 304 based on various criteria. By way of example and not limitation, operations may be added to the queue 304 based on a first in first out (FIFO) method, previously designated priorities, size of a file associated with the operation, or the operation's demand for resources. Many other criteria are contemplated for organizing operations added to the queue 304.

The user interface 110 may allow a user to prioritize the operations 108 in the queue 304 by specifying or changing a priority level of one or more of the operations 108 in the queue 304. For example, a column in the queue 304 may specify a priority level for each operation 108. The priority levels may include any number of levels, such as high, medium, low, or various levels relative to one another. Alternatively, the priority levels may be a sliding scale.

Alternatively or additionally, the user may move an operation 108 to the top of the list with or without changing the priority level of that operation 108. For example, if a user desires that operation 108(4) be performed first, the user may simply select an option to move the operation 108(4) to the top of the queue 304. In this manner, the user can quickly reorder the queue 304 of operations 108 and force a particular operation to be performed first. By processing the operations 108 serially, performance of the operation 108(4) may not be prolonged due to sharing of resources with other operations in parallel. In this manner, the user is provided with substantial control over the performance of the operations 108 and can choose to complete one or more operations 108 more quickly by running the operations 108 serially. Any remaining operations in the queue 304 may be paused and performed at a later time.

An expanded view of the user interface 110 can be generated to display additional information associated with each operation. For instance, additional information may include, but is not limited to, processing information, pending or active status, estimated time of completion, a number to designate the operation's position in the queue, file size associated with the operation, and so on.

Example Procedures

The following discussion describes techniques for managing operations via a user interface that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environments 100 and 200 of FIGS. 1-2, respectively, as well as the user interface of FIG. 3.

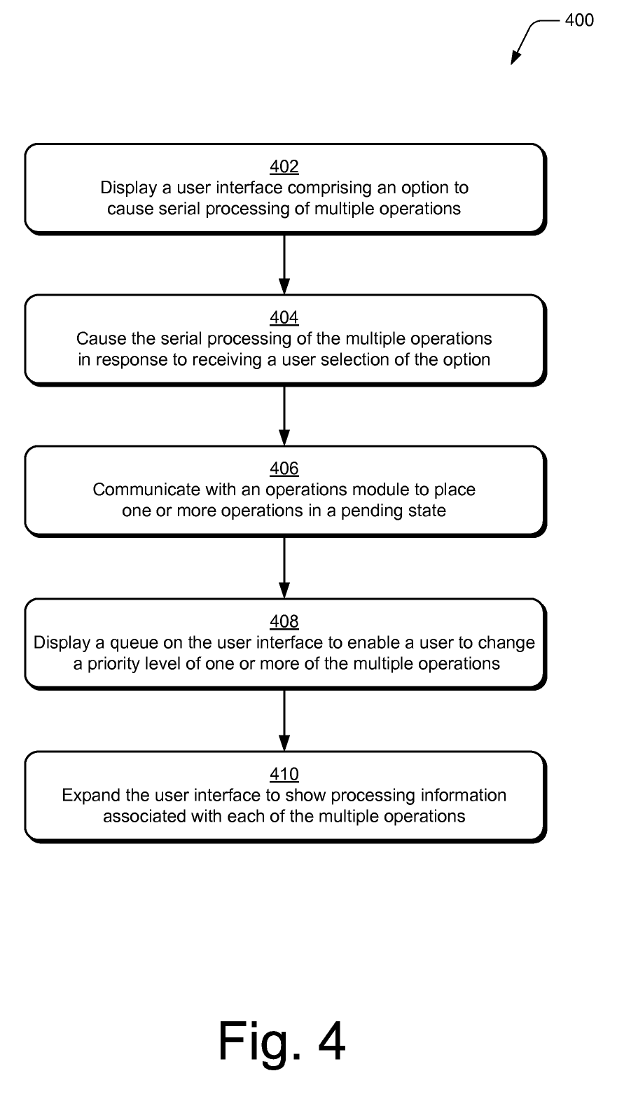

FIG. 4 depicts a procedure 400 in an example implementation that is operable to provide techniques for managing operations via a user interface. In at least some embodiments, procedure 400 may be performed by a suitably configured computing device such as computing device 102 either automatically or in response to a user command.

A user interface is displayed that comprises an option to cause serial processing of multiple operations (block 402). The option may include a variety of different configurations, some of which include, a button, a checkbox, a pull-down menu, and so on. While selecting the option may cause the operations to be performed serially, unselecting the option may cause the operations to run in parallel.

In response to receiving a user selection of the option, the multiple operations are processed serially (block 404). For example, in implementations, a callback method may be communicated to the operations module to place one or more of the operations in a pending state by, for example, pausing one or more of the operations (block 406).

A queue is displayed on the user interface to enable a user to change a priority level of one or more of the multiple operations (block 408). For instance, the queue may list the operations which are to be performed and the order in which the operations are scheduled for performance. The user interface may also enable a user to reorder the list of operations that are scheduled on the queue for serial processing.

Additionally, the user interface may be expanded to show processing information associated with each of the multiple operations (block 410). By way of example and not limitation, an expanded view of the user interface may include information such as pending or active status, estimated time for completion, or position in the queue. Other information may include estimated time to begin processing a pending operation, size of a file associated with the operation, or processing speed. Other information is also contemplated.

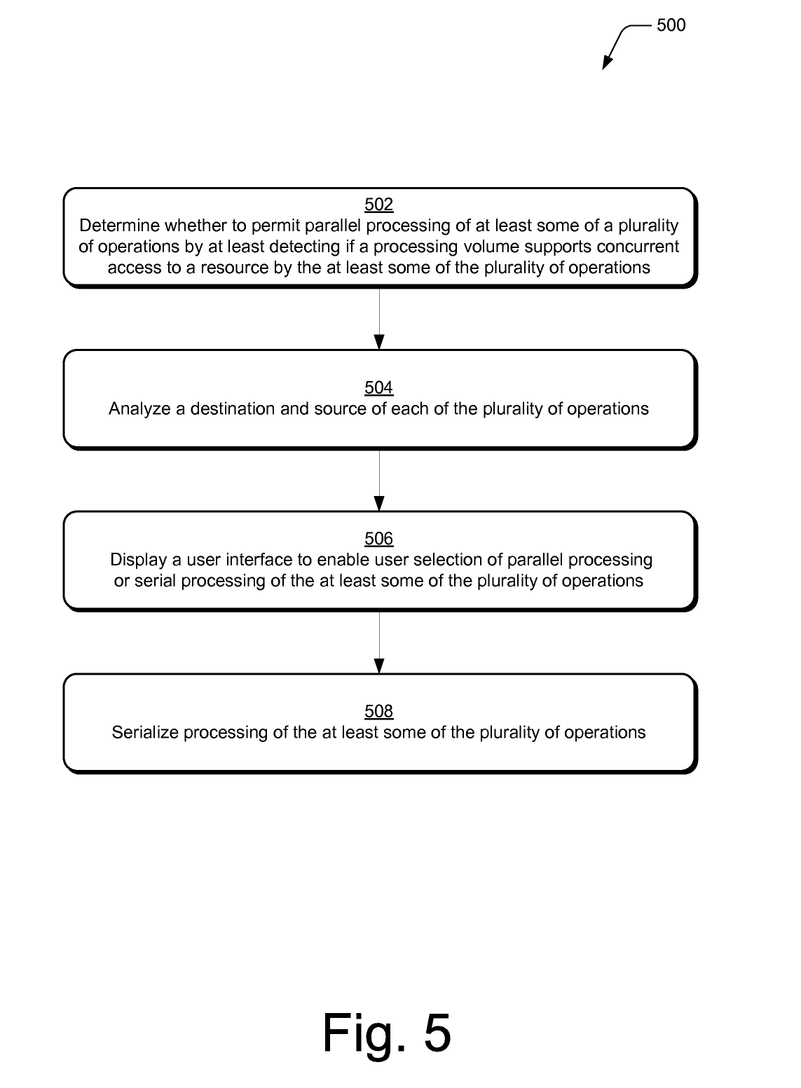

FIG. 5 is a flow diagram depicting a procedure 500 in an example implementation that is operable to provide techniques for managing operations via a user interface. In at least some embodiments, procedure 500 may be performed by a suitably configured computing device such as computing device 102, either automatically or in response to a user command.

A determination is made as to whether to permit parallel processing of at least some of a plurality of operations (block 502). This determination may be made automatically by, for example, detecting if a processing volume supports concurrent access to a resource by the plurality of operations. If it is determined that two or more operations running simultaneously may slow processing due to, for example, accessing the same memory, then parallel processing may not be permitted and the two or more operations may automatically be performed serially. If, however, two or more operations are disjoint, then the two or more operations may be allowed to run in parallel. This determination may help to optimize performance of the operations. In implementations, this optimization may be based on time slice of resources or concurrent access to the resources.

A destination and source of the operation can be analyzed (block 504). Analyzing both the destination and source can provide information related to processing volume of the destination and limitations of the source. Such information may be used to make the determination whether to permit parallel processing of the operations.

A user interface is displayed to enable user selection of parallel processing or serial processing of the at least some of the plurality of operations (block 506). A user selectable option is provided via the user interface that, if selected by a user, may cause the operations to be performed serially or in parallel.

Example Device

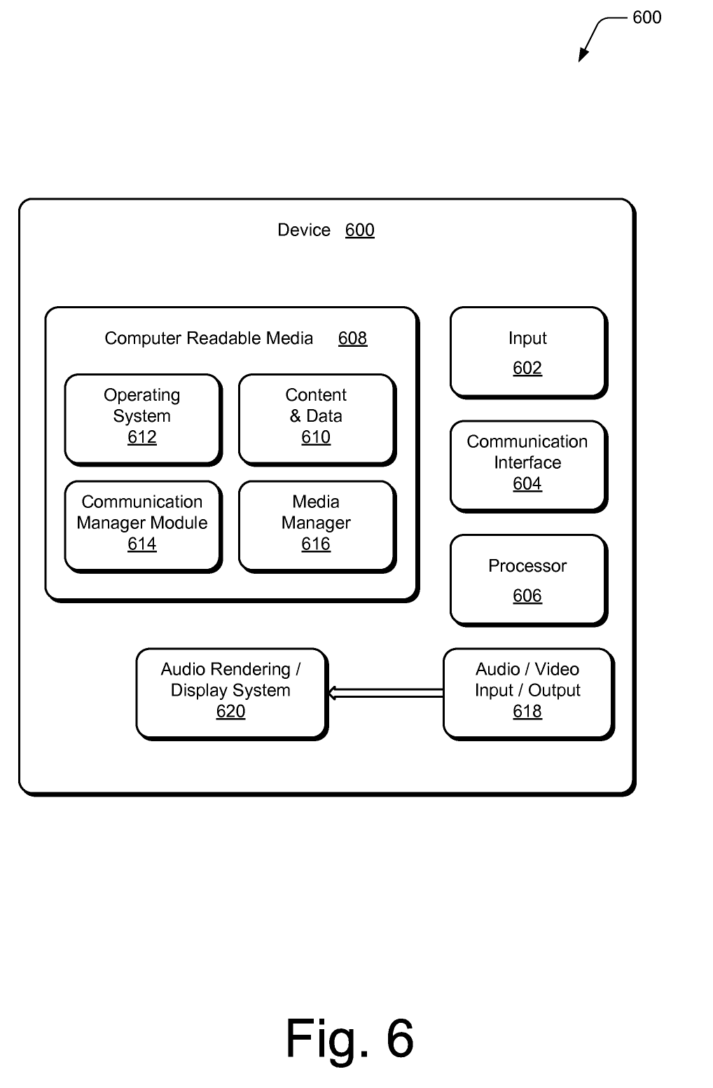

FIG. 6 illustrates various components of an example device 600 that can be implemented in various embodiments as any type of portable and/or computing device to implement embodiments of the techniques for managing operations via a user interface described herein. For example, device 600 can be implemented as the computing device 102 described with reference to FIG. 1. Device 600 can also be implemented to access a network-based server, such as the device server 118 described with reference to FIG. 1.

Device 600 includes input 602 that may include Internet Protocol (IP) inputs as well as other input devices, such as a keyboard. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface enables device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610, as well as device applications and any other types of information and/or data related to operational aspects of device 600. For example, an operating system 612 can be maintained as a computer application with the computer-readable media 608 and executed on processor 606. Device applications can also include a communication manager module 614 (which may be used to provide telephonic functionality) and a media manager 616.

Device 600 also includes an audio and/or video output 618 that provides audio and/or video data to an audio rendering and/or display system 620. The audio rendering and/or display system 620 can be implemented as integrated component(s) of the example device 600, and can include any components that process, display, and/or otherwise render audio, video, and image data. Device 600 can also be implemented to provide a user tactile feedback, such as vibrate and haptics.

Generally, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware or a combination thereof In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying a user interface comprising an option to cause serial processing of multiple operations; and
causing the serial processing of the multiple operations in response to receiving a user selection of the option.

2. The method of claim 1, further comprising communicating with an operations module to place one or more operations in a pending state to enable the serial processing of the multiple operations.

3. The method of claim 1, wherein the user interface further comprises a queue to enable a user to reorder a sequential order of the multiple operations for the serial processing.

4. The method of claim 1, further comprising displaying a queue on the user interface to enable a user to change a priority level of one or more of the multiple operations for serially processing the multiple operations.

5. The method of claim 4, further comprising expanding the user interface to show processing information associated with each of the multiple operations.

6. The method of claim 1, wherein the multiple operations are bound by one or more I/O devices.

7. The method of claim 1, further comprising determining whether to permit parallel processing of at least some of the multiple operations based on requests for concurrent access to a resource by the at least some of the multiple operations.

8. A system comprising:
a processor configured to process a plurality of operations; and
a user interface generated by one or more modules, the user interface configured to:
display an identifier each of the plurality of operations;
responsive to a user input, communicate with the processor to cause serial processing of the plurality of operations, wherein the user input comprises a change to a priority level of one or more of the plurality of operations; and
reorder a sequence in which the plurality of operations are to execute in response to the change to the priority level.

9. The system of claim 8, wherein the user interface is further configured to negotiate one or more individual operations to control a state of the one or more individual operations.

10. The system of claim 9, wherein the state of the one or more individual operations comprises a pending state or an active state.

11. The system of claim 8, wherein the user interface is further configured to communicate with an operations module that is configured to start, stop, pause, or resume processing of at least one of the plurality of operations.

12. The system of claim 8, wherein the user interface is further configured to determine whether two or more of the plurality of operations are attempting to access a same resource.

13. The system of claim 8, wherein the plurality of operations comprises operations associated with one or more I/O devices coupled to the system.

14. The system of claim 8, wherein the user interface is further configured to display the identifier of each of the plurality of operations in a queue.

15. The system of claim 8, wherein the user interface is further configured to add one or more operations to the queue based on a First-in/First-out method.

16. One or more computer-readable media comprising instructions that are executable by a computing device to cause the computing device to:
determine whether to permit parallel processing of at least some of a plurality of operations by at least detecting if a processing volume supports concurrent access to a resource by the at least some of the plurality of operations; and
display a user interface configured to enable user selection of parallel processing or serial processing of the at least some of the plurality of operations.

17. The one or more computer-readable media of claim 16, further comprising instructions to analyze a destination and source of each of the plurality of operations.

18. The one or more computer-readable media of claim 16, further comprising instructions to serialize processing of the at least some of the plurality of operations based on time slicing of resources.

19. The one or more computer-readable media of claim 16, further comprising instructions to deny parallel processing and cause serialization of the at least some of the plurality of operations in response to a determination that the at least some of the plurality of operations access a same resource.

20. The one or more computer-readable media of claim 16, further comprising instructions to permit parallel processing of the at least some of the plurality of operations in response to a determination that the at least some of the plurality of operations are disjoint.
